(19) United States
(12) Patent Application Publication
(10) Pub. No.: US 2012/0173486 A1
(43) Pub. Date: Jul. 5, 2012

(54) SYSTEM AND METHOD FOR DYNAMICALLY SELECTING STORAGE LOCATIONS OF REPLICAS IN CLOUD STORAGE SYSTEM

(76) Inventors: Chang-Sik PARK, Seoul (KR); Mi-Jeom Kim, Gyeonggi-do (KR); Hyo-Min Kim, Seoul (KR); Eo-Hyung Lee, Gyeonggi-do (KR); Jin-Kyung Hwang, Gyeonggi-do (KR)

(21) Appl. No.: 13/341,341

(22) Filed: Dec. 30, 2011

(30) Foreign Application Priority Data
Dec. 31, 2010 (KR) 10-2010-0140652

(51) Int. Cl. G06F 7/00

(52) U.S. Cl. 707/634; 707/E17.032; 707/E17.005

(57) ABSTRACT

System and method for dynamically selecting storage locations of replicas in cloud storage system. The cloud storage system may include a plurality of data nodes and a server. The plurality of data nodes may be geographically distributed. Each one of the plurality of data nodes may store an object and at least one replica thereof and provide stored replica to a user. The server may be coupled to the plurality of data nodes through a network. The server may migrate at least one replica according to changes of the location of the user.

### CROSS REFERENCE TO PRIOR APPLICATIONS

The present application claims priority under 35 U.S.C. §119 to Korean Patent Application No. 10-2010-0140652 (filed on Dec. 31, 2010), which is hereby incorporated by reference in its entirety.

### FIELD OF THE INVENTION

Apparatuses and methods consistent with the present invention relate to a cloud storage system. More particularly, apparatuses and methods consistent with the present invention relate to a cloud storage system for dynamically migrating at least one replica to a data node according to changes of user locations.

### BACKGROUND OF THE INVENTION

A cloud storage system may provide a storage service to a user. For example, a cloud storage system may include a plurality of data nodes geographically distributed and store an object and replicas thereof in the data nodes in response to user requests. Such a cloud storage system may also provide a user with one of the replicas stored in the data nodes.

When the cloud storage system stores replicas, the cloud storage system may consider the location of a user. For example, a cloud storage system may store replicas in data nodes relatively close to the location of a user. In this manner, the cloud storage system may provide a replica to the user quickly.

However, the locations of a user may frequently change. For example, a user may frequently uses mobile devices while traveling around multiple locations. Further, a user may frequent multiple remote locations and a cloud storage system may store replicas in data nodes of all of these frequently visited locations that may all be a relatively far distance from each other. Therefore, there is a demand for developing a cloud storage system to migrate at least one replica according to changes of user locations.

### SUMMARY OF THE INVENTION

Embodiments of the present invention overcome the above disadvantages and other disadvantages not described above. Also, the present invention is not required to overcome the disadvantages described above, and an embodiment of the present invention may not overcome any of the problems described above.

In embodiments, a cloud storage system may dynamically change locations of replicas according to a current location of a user. In embodiments, a cloud storage system may dynamically select a storage location of a replica according to changes of a user location. In embodiments, a cloud storage system may detect a current location of a user, select a replica that has not been used for a relatively long time, and migrate the selected replica to a data node close to the detected location.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates a cloud storage system, in accordance with embodiments;

FIG. 2 illustrates a server of a cloud storage system, in accordance with embodiments;

FIG. 3 illustrates operation of a cloud storage system when a user travels one location to another, in accordance with embodiments; and

FIG. 4 illustrates a method for dynamically selecting storage locations of replicas in a cloud storage system, in accordance with embodiments.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

A cloud storage system may store an object and replicas thereof in a plurality of data nodes in response to a user request. The object may be any types of data. For example, the object may be document files and multimedia files. The document files may include Microsoft (MS) word documents or Portable Document Format (PDF) files. The multimedia files may include audio files for songs and image files for still and/or motion pictures. The present invention, however, is not limited thereto.

For many purposes such as high safety and availability, a cloud storage system may create replicas of the object and distributedly store the replicas in a plurality of data nodes. In order to effectively store the object and the replicas thereof, a cloud storage system may refer to cloud storage policies to select data nodes for storing the object and the replicas thereof. The cloud storage policies may define storage locations and rules for storing the object and the replicas. The cloud storage polices may include a location diversity policy. The location diversity policy may be a rule defined for distributing replicas in data nodes of at least N areas where N is a natural number greater than 1. Such a diversity policy may improve storage safety and stability. The cloud storage polices may further include a locality policy. The locality policy may define a rule for selecting a data node. According to the locality policy, a cloud storage system may select a data node relatively close to a location of a related user. Because of the locality policy, the related user may access a desired object or a replica thereof more quickly. A user, however, may travel one location to another after initially storing the replicas. In this case, related replicas may be stored in data nodes that are separated from the user at a long distance.

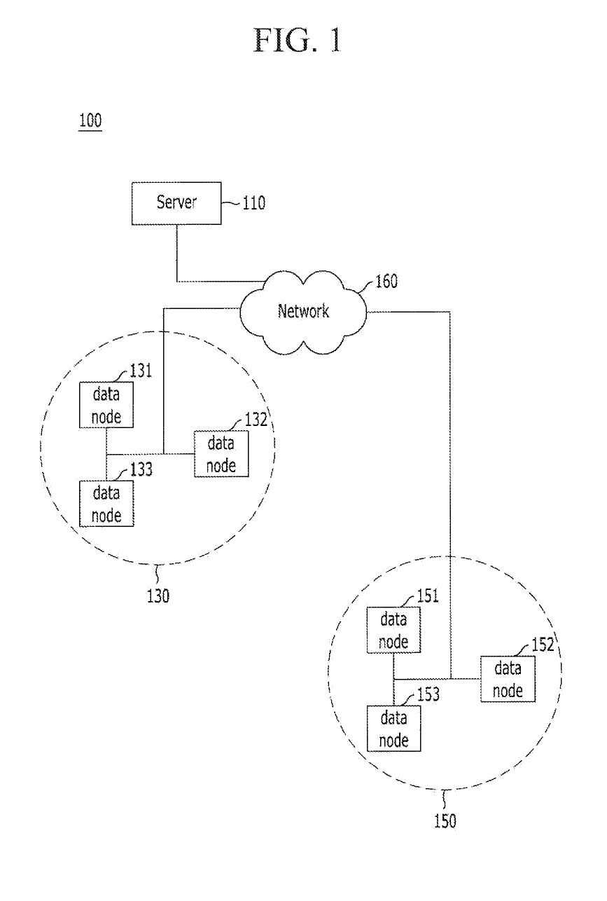

In embodiments, a cloud storage system may migrate at least one replica to a data node relatively close to a current location of a user in order to effectively provide a replica to a user. Since at least one replica is migrated to a data node relatively close to the current location of the user, the user may access at least one replica quickly and effectively although the location of the user is frequently changed. Hereinafter, a cloud storage system in accordance with embodiments will be described, in detail, with reference to FIG. 1 to FIG. 4.

FIG. 1 illustrates a cloud storage system, according to embodiments. Cloud storage system 100 may include server 110, plurality of data nodes 131 to 133 and 151 to 153, and network 160. Plurality of data nodes 131 to 133 and 151 to 153 may be geographically distributed. For example, data nodes 131 to 133 may be located at first location 130, and data nodes 151 to 153 may be located at second location 150. First location 130 may be separated from second location 150 by a relatively long distance. For example, first location 130 may be Seoul, Korea and second location 150 may be New York, U.S.A., but embodiments are not limited thereto. Plurality of data nodes 131 to 133 and 151 to 153 may store an object and replicas thereof in response to control of the server 110. Furthermore, plurality of data nodes 131 to 133 and 151 to 153 may provide a stored object or a stored replica to a user in response to control of the server 110.

Server 110 may be coupled to plurality of data nodes 131 to 133 and 151 to 153 through network 160. Server 110 may distributedly store replicas of an object in plurality of data nodes 131 to 133 and 151 to 152. In order to effectively distribute the replicas, server 110 may refer to a cloud storage policy. Due to the cloud storage policy, the replicas may not be stored in a single data node located at one area.

Server 110 may dynamically migrate at least one replica according to according to changes of user locations. For example, server 100 may detect the current location of a user when a user travels from one location to another and migrate at least one replica to a data node relatively close to a user before and/or after the travel. In such a manner, a desired replica may be provided to a user more quickly. In order to effectively migrate at least one replica, server 110 may refer to a location attribute and an access time attribute in embodiments. An object and each replica thereof may be mapped to the location attribute and the access time attribute, according to embodiments. The location attribute may include information on the current location of a user. The access time attribute may include information on a most recent time the replica was accessed. The location attribute may be set up manually by a user or automatically by server 110.

In order to manually set up the location attribute, server 110 may provide a user interface to a user. The user may set up a storage location in the location attribute to indicate the current location of the user through the provided user interface. Particularly, the user may set up a destination of travel as the storage location in the location attribute before the travel.

In order to automatically determine the current location of a user, server 110 may detect a current location of a user based on an Internet Protocol (IP) address and/or Global Positioning System (GPS) data from user equipment that a user uses for accessing cloud storage system 100. Server 110 may set up the storage location of the location attribute based on the detected location of the user. Server 110 may automatically detect the current location of the user and set up the storage location of the location attribute when a user accesses cloud storage system 100, but embodiments are not limited thereto. For example, server 110 may monitor the current location of a user at a regular interval.

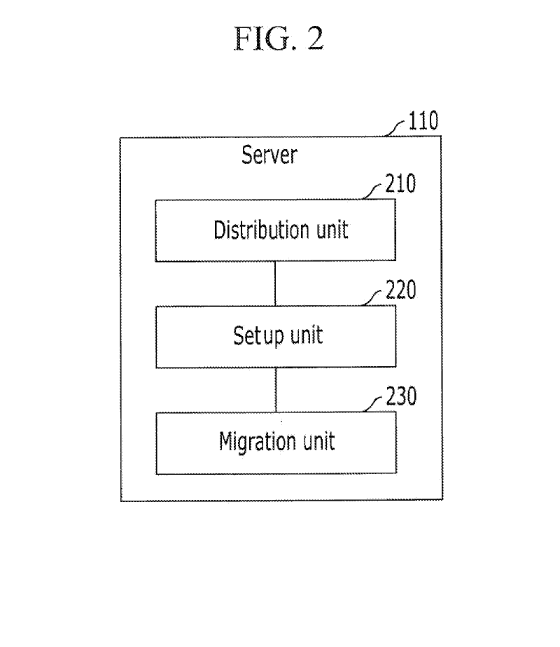

Server 110 may select a replica, select a data node to store the selected replica, and migrate the selected replica to the selected data node. Server 110 may refer to the location attribute and the access time attribute of replicas. For example, server 110 may select a replica that has not been used for a relatively long time among replicas based on an access time included in the access time attribute. Furthermore, server 110 may select a data node relatively close to the current location of the user based on the storage location of the location attribute. Thereafter, server 110 may migrate the selected replica to the selected data node. Hereinafter, the server 110 will be described, in more detail, with reference to FIG. 2.

FIG. 2 illustrates a server of a cloud storage system, according to embodiments. Server 110 may include distribution unit 210, setup unit 220, and migration unit 230. Distribution unit 210 may distributedly store replicas of an object in plurality of data nodes 131 to 133 and 151 to 153, which are geographically distributed. Distribution unit 210 may refer to a cloud storage policy to distribute the replicas in plurality of data nodes 131 to 133 and 151 to 153. For example, distribution unit 210 may not store multiple replicas in a single data node or data nodes located at one location. Since the replicas are distributed over global locations, the cloud storage system 100 may store replicas with improved storage safety. For example, when one replica is damaged due to errors in a related network, other replica can be provided to a user.

Setup unit 220 may set up a storage location of at least one replica based on a current location of a user. For example, setup unit 220 may set up a storage location in a location attribute based on a current location of a user. The storage location may be set up to be close to a current location of a user. As described above, the location attribute may be set up manually by a user or automatically by the setup unit 220. For the manual setup, setup unit 220 may provide a user interface to a user. A user may set up the storage location in the location attribute to indicate a current location of the user through the provided user interface. Particularly, a user may set up a destination of travel as the storage location in the location attribute before the travel. The user interface may allow a user to easily designate a storage location for storing at least one replica. For automatic setup, setup unit 220 may detect a current location of a user. In order to detect the current location of the user, setup unit 220 may refer to an IP address assigned to user equipment used for accessing the cloud storage system 100. Alternatively, setup unit 220 may refer to GPS data collected in a GPS module of the user equipment, but embodiments are not limited thereto. Setup unit 220 may automatically set up the storage location of the location attribute based on the detected location of the user when the user accesses the cloud storage system 100 for a desired replica.

Migration unit 230 may select a replica, select a data node, and migrate the selected replica to the selected data node. Migration unit 230 may select a replica that has been unused for a relatively long time, among the replicas distributedly stored in plurality of data nodes 131 to 133 and 151 to 153. When a user does not frequently visit a certain location, a replica stored close to that certain location may be unused for relatively longer time, compared to other replicas stored in other locations that the user visits frequently. Accordingly, migration unit 230 may select a replica that has been unused for a relatively long time. In this manner, frequent migration of a replica may be prevented. In order to select, migration unit 230 may refer to the access time attribute. As described above, the access time attribute may include information relating to time of accessing a corresponding replica. Based on the access time attribute, migration unit 230 may determine which replica has not been used for a relatively long time, compared to other replicas. Embodiments, however, are not limited thereto. For example, various factors may be considered to select a replica to be migrated. Factors may include a location of a data node, the current location of a user, a processing load of a data node, traffic volume of a related network, and transmission rate of a related network. In embodiments, migration unit 230 may select a replica based on user preferences.

Migration unit 230 may select a data node relatively close to the current location of a user based on the storage location in the location attribute. Embodiments, however, are not limited thereto. For example, migration unit 230 may select a data node based on various factors including a location of a data node, the current location of the related user, processing load of a data node, traffic amount of a related network, and transmission rate of a related network. In embodiments, migration unit 230 may migrate the selected replica to the selected data node.

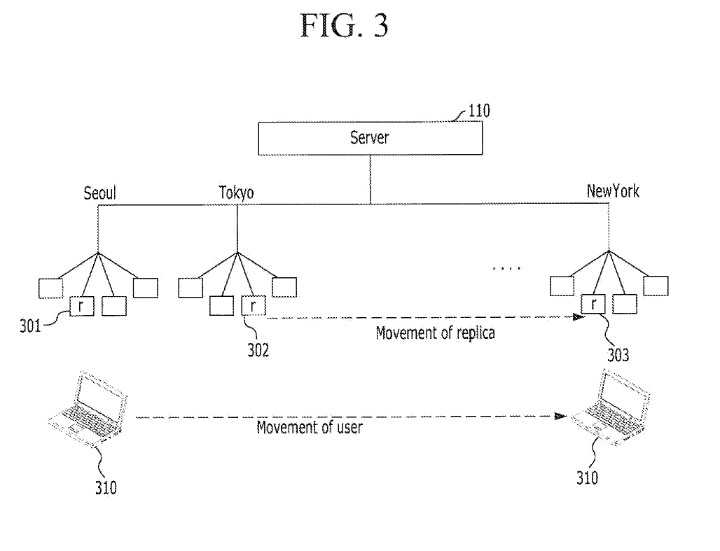

FIG. 3 illustrates operation of a cloud storage system when a user travels from one location to another, in accordance with embodiments. A plurality of data nodes may be geographically distributed. For example, data node 301 may be located at Seoul, Korea. Data node 302 may be located at Tokyo, Japan and data node 303 may be located at New York, U.S.A. Replicas r of an object may be distributedly stored in data nodes 301, 302, and 303 according to a location diversity policy. Since the replicas r are distributedly stored in plurality of data nodes 301, 302 and 303, storage safety and stability may be enhanced, even though errors occur in data nodes of a location.

When, for example, user 310 travels from Seoul to New York, server 110 may migrate a replica r stored in data node 302 in Tokyo to data node 303 in New York, in accordance with embodiments. Since data node 303 is closer to user 310, compared to other data nodes 301 and 303, then replica r may be provided to user 310 more quickly, in accordance with embodiments.

In order for migration, server 110 may determine a current location of user 310 based on a storage location, of a location attribute. As described above, user 310 may set up the storage location of the location attribute as New York before user 310 travels from Seoul to New York. It may be performed through a user interface provided from setup unit 220 of server 110, as shown in FIG. 2. Alternatively, server 110 may automatically detect that a current location of user 310 is New York when user 310 accesses cloud storage system 100 after travel. Based on the storage location of the location attribute, server 110 may select a data node storing the replica r and relatively close to New York. As a result, server 110 may select data node 303 located in New York.

After selecting data node 303, server 110 may select at least one replica to be migrated based on an access time of each replica, included in an access time attribute. Server 110 may select a replica that has not been used for the longest time. For example, it is assumed that a replica r stored in data node 302 located at Tokyo has an access time earlier that other replicas r stored in data nodes 301 and 303. Under this assumption, server 110 may compare access times of related replicas r stored in data nodes 301, 302, and 303, and select the replica r stored in data node 302.

Some example reasons for selecting a replica that has not been used for a relatively long time are as follows: When a user does not frequently visit a certain location, a replica stored around the certain location may be unused for a relatively long time, compared to other replicas stored in other locations that the user visits frequently. Accordingly, server 110 may select a replica that has not been used for a relatively time. In this manner, it may minimize frequent migration of replicas, in embodiments.

After selecting the replica to be migrated, server 110 may migrate the selected replica stored in data node 302 to data node 303. After migration, user 310 may be provided with the replica stored in data node 303 which is located at New York where user 310 currently presents. Therefore, the replica may be quickly provided to user 310, in accordance with embodiments.

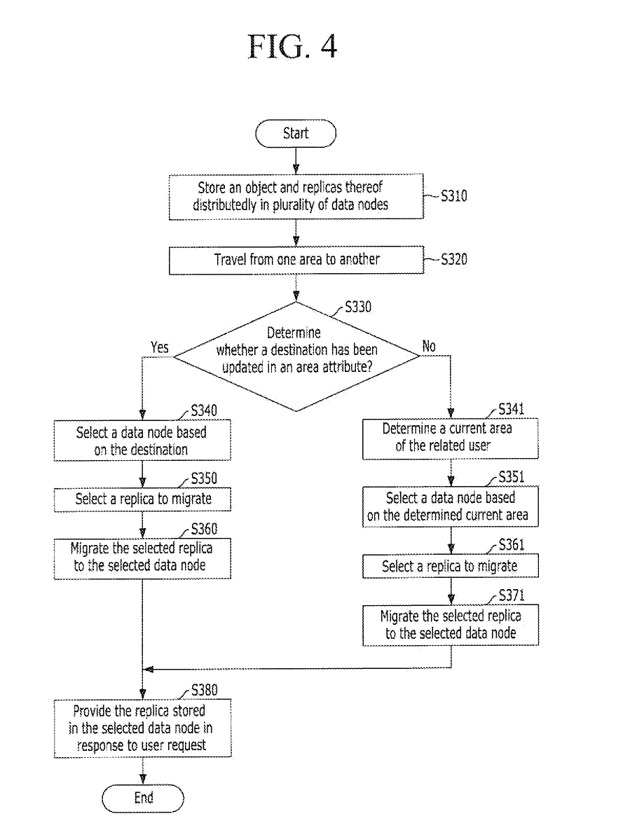

FIG. 4 illustrates a method for dynamically selecting storage locations of replicas in a cloud storage system, in accordance with embodiments. An object and replicas thereof may be distributedly stored in a plurality of data nodes S310. For example, cloud storage system 100 may initially store an object and replicas thereof in plurality of data nodes 131 to 133 and 151 to 153, which may be geographically distributed.

A related user may travel from one location to another S320. For example, a related user may make a business trip from Seoul to New York. When the related user accesses cloud storage system 100 for using an object stored in cloud storage system 100 after the travel, a determination may be made as to whether or not a destination of a travel has been updated at a location attribute of the object S330. For example, cloud storage system 100 may determine whether the related user has designated a destination of travel before leaving for the trip. The related user may record the destination of travel as a storage location in the location attribute of the object before the travel.

In case the related user has previously designated the destination before the travel (Yes—S330), a data node relatively close to the destination may be selected S340. For example, the user may manually set up the destination of the travel as a storage location in a location attribute. Then, a data node close to the destination of the travel may be selected.

After selecting the data node, storage system 100 may search for a replica to be migrated S350. For example, a replica that has not been used for a relatively long time may be selected among the replicas, but embodiments are not limited thereto. In embodiments, the replica may be selected by the related user based on user preference.

A selected replica may be migrated to selected data node S360. For example, cloud storage system 100 may move the selected replica from an original data node to the selected data node. The moved replica may be provided to the related user when the related user desires to use S380. For example, when the related user desires to use the object, the replica stored in the selected data node may be provided to the related user. Since the selected data node is relatively close to the current location of the related user compare to other replicas, the user may be provided with the object more quickly, in accordance with embodiments.

If the related user has not designated the destination in the location attribute before the travel (No—S330), a current location of the related user may be determined S341. For example, cloud storage system 100 may determine the current location of the related user. Such determination may be made based on an Internet Protocol (IP) address of user equipment that the related user uses to access the cloud storage system 100, but embodiments are not limited thereto. Alternatively, cloud storage system 100 may use global positioning system (GPS) data collected in a GPS module of the user equipment.

A data node relatively close to the current location of the related user may be selected S351. For example, cloud storage system 100 may select a data node based on the detected current location of the related user. Embodiments, however, are not limited thereto. A data node may be selected based on various factors including a location of a data node, the current location of the related user, a processing load of a data node, traffic volume of a related network, and transmission rate of a related network. In embodiments, cloud storage system 100 may select a data node closest to the current location of the related user.

A replica to be migrated may be selected S361. For example, cloud storage system 100 may select one replicas that has not been used for a relatively long time. The selected replica may be moved from an original data node to the selected data node S371. For example, cloud storage system 100 may migrate the selected replica from an original data node to the selected data node. The selected replica may be provided to the related user 5380. For example, cloud storage system 100 may provide the selected replica to the related user. Embodiments, however, are not limited thereto. In embodiments, the selected replica may be provided to the related user before moving the selected replica to the selected data node. Alternatively, the selected replica may be provided to the related user while moving the selected replica to the selected data node. Since the selected data node is relatively close to the location of the related user compare to other replicas, the user may be provided with the object more quickly.

In accordance with embodiments, the cloud storage system may designate storage locations of replicas manually or automatically. Therefore, a cloud storage system may enable a user to upload and download files quickly, regardless of the location of the user.

In embodiments, a cloud storage system may include a plurality of data nodes and a server. The plurality of data nodes may be geographically distributed. Each one of the plurality of data nodes may be configured to store an object and at least one replica thereof and to provide the stored replica to a user. The server may be coupled to the plurality of data nodes through a network. The server may be configured to migrate at least one replica according to changes of the location of the user.

The server may select a data node based on a location attribute and select a replica based on an access time attribute. Thereafter, the server may migrate the selected replica to the selected data node.

The location attribute may include information on a storage location for storing the at least one replica, and the server may select a data node based on the storage location.

The storage location may be a current location of the user, and the server may select a data node relatively close to the current location of the user based on the storage location included in the location attribute.

The storage location may be a destination of travel that the user will have. The server may select a data node relatively close to the destination of travel and migrate at least one replica to the selected data node before and/or after the travel. The location attribute may be manually set up by the user, and the server may provide a user interface that enables the user to set up a storage location in the location attribute.

The location attribute may be automatically set up by the server, and the server may detect the location of the user and set up a storage location in the location attribute based on the detected location of the user. The server may refer to an Internet Protocol (IP) address of user equipment used by the user for accessing the cloud storage system. Alternatively, the server may refer to a Global Positioning System (GPS) data collected in a GPS module of user equipment used by the user for accessing the cloud storage system.

The access time attribute may include information on the access time of a respective replica, and the server may compare the access times of the replicas and select a replica that has not been used for a relatively long time based on the comparison result.

In embodiments, a cloud storage system may include a plurality of data nodes and a server. The plurality of data nodes may be geographically distributed. The plurality of data nodes may be configured to store an object and replicas of the object and to provide a stored replica to a user. The server may be configured to migrate at least one replica to at least one of the plurality of data nodes based on a current location of a user.

The server may comprise a distribution unit, a setup unit, and a migration unit. The distribution unit may be configured to distributedly store the replicas into the plurality of data nodes according to a cloud storage policy. The setup unit may be configured to set up a location attribute based on a current location of the user. The migration unit may be configured to select a data node based on the location attribute, select at least one replica to be migrated, and migrate the selected at least one replica to the selected data node.

The cloud storage policy may define a rule for storing the replicas not to be stored in a single data node and/or data nodes located at one location. The setup unit may provide a user interface for enabling the user to set up the location attribute, and the migration unit may select a data node relatively close to the location of the user based on the location attribute.

The setup unit may detect the location of the user based on an Internet Protocol (IP) address and/or a Global Positioning System (GPS) data of user equipment used by the user for accessing the cloud storage system. The setup unit may set up the location attribute based on the detected IP address and/or GAS data. The migration unit may select a data node relatively close to the location of the user based on the location attribute.

The migration unit may select at least one replica based on an access time attribute that includes information on the access time of a respective replica, compare the access times of the replicas, and select a replica that has been unused for a relatively long time based on the comparison result.

In embodiments, a method may be provided for migrating at least one replica according to changes of user location. The method may include storing an object and replicas thereof in a plurality of data nodes geographically distributed, and migrating at least one replica from a data node to another data node upon change of a user location.

The invention may also be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium may also be distributed over network coupled computer systems so that the computer readable code is stored and executed in a distributed fashion. Also, functional programs, codes, and code segments for accomplishing the present invention may be easily construed by programmers skilled in the art to which the present invention pertains.

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cloud storage system, comprising:
a plurality of data nodes geographically distributed each configured to store an object and at least one replica thereof and to provide a stored replica to a user; and
a server coupled to the plurality of data nodes through a network and configured to migrate at least one replica according to changes of the location of the user.

2. The cloud storage system of claim 1, wherein the server:
selects a data node based on a location attribute;
selects a replica based on an access time attribute; and
migrates the selected replica to the selected data node.

3. The cloud storage system of claim 2, wherein:
the location attribute includes information on a storage location storing the at least one replica; and
the server selects a data node based on the storage location.

4. The cloud storage system of claim 3, wherein:
the storage location is a current location of the user; and
the server selects a data node relatively close to the current location of the user based on the storage location included in the location attribute.

5. The cloud storage system of claim 2, wherein:
the storage location is a destination location that the user will travel to; and
the server selects a data node relatively close to the destination of travel and migrates at least one replica to the selected data node before and/or after the travel.

6. The cloud storage system of claim 2, wherein:
the location attribute is manually set by the user; and
the server provides a user interface that enables the user to set a storage location in the location attribute.

7. The cloud storage system of claim 2, wherein:
the location attribute is automatically set by the server; and
the server detects the location of the user and sets a storage location in the location attribute based on the detected location of the user.

8. The cloud storage system of claim 7, wherein the server refers to an Internet Protocol (IP) address of a user equipment used by the user for accessing the cloud storage system.

9. The cloud storage system of claim 8, wherein the server refers to a Global Positioning System (GPS) data collected in a GPS module of a user equipment used by the user for accessing the cloud storage system.

10. The cloud storage system of claim 2, wherein the access time attribute includes information on access times of a respective replica; and
the server compares the access times of the replicas and selects a replica that has not been used for a relatively long time based on the comparison result.

11. A cloud storage system comprising:
a plurality of data nodes geographically distributed and configured to store an object and replicas of the object and to provide a stored replica to a user; and
a server configured to migrate at least one replica to at least one of the plurality of data nodes based on a current location of a user.

12. The cloud storage system of claim 11, wherein the server comprises:
a distribution unit configured to distributedly store the replicas into the plurality of data nodes according to a cloud storage policy;
a setup unit configured to set a location attribute based on a current location of the user; and
a migration unit configured to select a data node based on the location attribute, select at least one replica to be migrated, and migrate the selected at least one replica to the selected data node.

13. The cloud storage system of claim 12, wherein the cloud storage policy defines a rule for storing the replicas not to be stored in at least one of a single data node and data nodes located at one location.

14. The cloud storage system of claim 12, wherein:
the setup unit provides a user interface for enabling the user to set up the location attribute; and
the migration unit selects a data node relatively close to the location of the user based on the location attribute.

15. The cloud storage system of claim 12, wherein:
the setup unit detects the location of the user based on at least one of an Internet Protocol (IP) address and Global Positioning System (GPS) data of a user equipment used by the user for accessing the cloud storage system;
the setup unit sets the location attribute based on at least one of the detected IP address and GPS data; and
the migration unit selects a data node relatively close to the location of the user based on the location attribute.

16. The cloud storage system of claim 12, wherein the migration unit:
selects at least one replica based on an access time attribute that includes information on access times of a respective replica;
compares the access times of the replicas;
select a replica that has been unused for a relatively long time based on the comparison result.

17. A method for migrating at least one replica according to changes of user location, the method comprising:
storing an object and replicas thereof in a plurality of data nodes that are geographically distributed; and
migrating at least one replica from a data node to another data node upon change of a user location.

18. The method of claim 17, wherein the migrating at least one replica comprises:
selecting a data node based on a location attribute;
selecting a replica to be migrated based on an access time attribute; and
migrating the selected replica to the selected data node.

19. The method of claim 18, wherein the selecting a data node comprises:
setting the location attribute to include a current location of a user; and
selecting a data node relatively close to the current location of the user.

20. The method of claim 18, wherein the selecting a replica comprises:
comparing access times of each replica included in the access time attribute; and
selecting a replica that has not been used for a relatively long time based on the comparison result.
